(19) United States
(12) Patent Application Publication
(10) Pub. No.: US 2005/0055773 A1
(43) Pub. Date: Mar. 17, 2005

(54) Patient table

(75) Inventor: Robert Stephen Cooke, Surrey (GB)

Correspondence Address: BROMBERG & SUNSTEIN LLP, 125 SUMMER STREET, BOSTON, MA, 02110-1618, US

(73) Assignee: ELEKTA AB, Stockholm (SE)

(21) Appl. No.: 10/691,858

(22) Filed: Oct. 23, 2003

(30) Foreign Application Priority Data
Sep. 11, 2003 (GB) 0321277.6

(51) Int. Cl. A61G 13/00

(52) U.S. Cl. 5/620; 5/600

(57) ABSTRACT

A patient table has a removable end portion. This portion can thus be detached and replaced with an alternative end portion having a different shape, ideally having apertures in the areas where the beam requires access. This allows a wider range of shapes to be provided than can be achieved using configurable tables such as those noted above, whilst maintaining the mechanical strength required of the table. The parts of the table can be attached in a variety of ways. A preferred means of joining the two parts is to provide at least two engagement sites for mutual inter-engagement on each section, with the engagement sites of each part being spaced along the length thereof, the first engagement site closest the end of the respective section being adapted to engage on the top side thereof and the second engagement site more distant from the end being adapted to engage on the underside thereof. It is further preferred that the engagement sites are arranged with a central engagement site and two lateral engagement sites proximate the edges of the table. The second engagement site(s) of each part can be a ledge beneath which the first engagement site(s) of the other parts can locate. This ledge can be defined by an underlying recess, or as one face of a protruding pin. A recess can be formed with a surface which angles upwardly away from the edge of the ledge, thereby retaining the two parts together. The first engagement sites can likewise be formed as surfaces upon which the second engagement sites can rest. They can be provided with a profile adapted to retain engagement, such as a rounded recess for accepting a pin, or a surface that slopes downwardly away from the edge thereof so as to be retained in a corresponding recess.

### FIELD OF THE INVENTION

The present invention relates to a patient table.

### BACKGROUND ART

Patients undergoing radiotherapy and similar treatments need to be supported in a prone or reclining position during the treatment. The treatment generally involves passing a beam of X or other radiation through the tumour or other affected area of the patient to destroy the tissue in its path. The treatment will usually be segmented into several parts so that each part uses a different direction of approach through the patient. In this way, healthy tissue around the tumour receives only a significantly lower dose, from which it is better able to recover.

The patient must be supported during this procedure, in a manner that allows access for the beam from beneath, to offer a sufficient range of approach directions. This means that the table on which the patient lies must be transparent to radiation in the vicinity of the beam. This is difficult to achieve in a solid table with adequate mechanical properties to support a human, and existing designs therefore include rotateable or otherwise moveable sections to allow a user to move these into an alternative position, out of the beam path.

### SUMMARY OF THE INVENTION

The requirement that the load bearing parts of the patient table include moveable elements (as noted above) introduces a significant level of complexity into the design of tables. It would be preferable to avoid this and adopt a design that could allow uninterrupted access for the beam but which was nevertheless simple in design. The present invention is based on the approach of providing a table with a removable end portion. This portion can thus be detached and replaced with an alternative end portion having a different shape, ideally having apertures in the areas where the beam requires access.

This allows a wider range of shapes to be provided than can be achieved using configurable tables such as those noted above, whilst maintaining the mechanical strength required of the table.

The parts of the table can be attached in a variety of ways. One simple means of doing so is to form one or other part with projecting rods, which can be received in corresponding sockets on the other part.

A preferred means of joining the two parts is to provide at least two engagement sites for mutual inter-engagement on each section, with the engagement sites of each part being spaced along the length thereof, the first engagement site closest the end of the respective section being adapted to engage on the top side thereof and the second engagement site more distant from the end being adapted to engage on the underside thereof. This provides a secure engagement, which is nevertheless easy to manipulate into place, an important factor given that the sections are likely to be relatively heavy.

It is further preferred that the engagement sites are arranged with a central engagement site and two lateral engagement sites proximate the edges of the table. This produces a symmetrical arrangement that is more stable in use.

The second engagement site(s) of each part can be a ledge beneath which the first engagement site(s) of the other parts can locate. This ledge can be defined by an underlying recess, or as one face of a protruding pin. A recess can be formed with a surface which angles upwardly away from the edge of the ledge, thereby retaining the two parts together.

The first engagement sites can likewise be formed as surfaces upon which the second engagement sites can rest. They can be provided with a profile adapted to retain engagement, such as a rounded recess for accepting a pin, or a surface that slopes downwardly away from the edge thereof so as to be retained in a corresponding recess.

### BRIEF DESCRIPTION OF THE DRAWINGS

An embodiment of the present invention will now be described by way of example, with reference to the accompanying figures in which;

FIG. 1 is a perspective view of a first embodiment of the present invention;

FIG. 2 is a perspective view of a second embodiment of the present invention;

FIG. 3 is a section on III-III of FIG. 2;

FIG. 4 is a perspective view of a third embodiment of the present invention;

FIG. 5 is a perspective view of a fourth embodiment of the present invention;

FIG. 6 is a perspective view of a fifth embodiment of the present invention;

FIGS. 7 and 8 are plan views of a sixth and seventh embodiment, respectively;

FIG. 9 is a perspective view from beneath of the table portion and parts of the end portion of an eighth embodiment;

FIG. 10 is a perspective view from above of the end portion and parts of the table portion of the eighth embodiment; and

FIG. 11 is a perspective view from beneath of the end portion and parts of the table portion of the eighth embodiment.

### DETAILED DESCRIPTION OF THE EMBODIMENTS

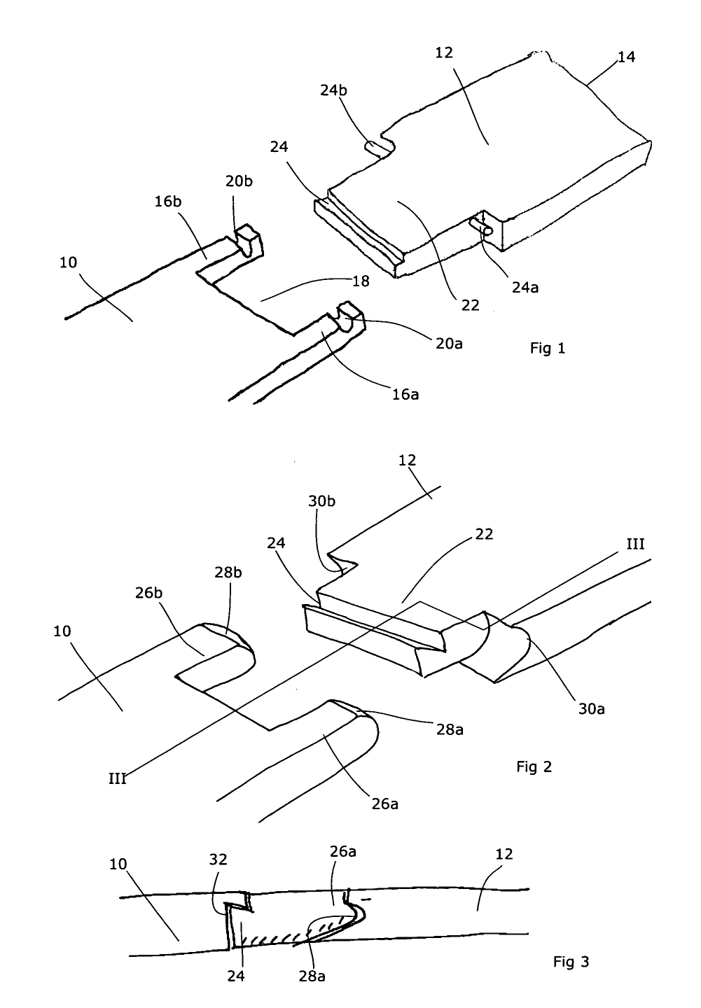

FIG. 1 shows the first embodiment of the invention. A table has a removable end portion 12 separable from the main table portion 10. The shape of the tip 14 of the end portion 12 is shown as being a simple square, but it is of course envisaged that the end portion 12 will be one such end portion selected from a plurality of end portions having substantially the same engagement areas (described later) but varying in the shape of their tips 14. This will allow an appropriately shaped tip to be selected so as to provide adequate support for the patient combined with a clear beam path.

The table portion 10 is formed with a locking system for accepting the end portion 12. This comprises a pair of arms 16A, 16B projecting from the end of the table portion 10 along either lateral side thereof and defining between them a recess 18. On the top surfaces of each of the projections 16A, 16B, there is a socket 20A, 20B respectively, in the form of a recess extending from the upper surface thereof.

The end portion 12 has a central projection 22 which corresponds to the recess 18 defined between the arms 16A, 16B of the table portion 10. A pair of posts 24A, 24B extend laterally from the sides of the projection 22 at locations corresponding to the recesses 20A, 20B. At the tip of the projection 22, a step 24 is formed on the top surface, which is able to engage beneath a corresponding lip (not visible) in the end of the table portion 10.

Thus, to join the two paths, the end portion 12 is brought towards the table portion 10 in an inclined state such that the posts 24A, 24B are higher than step 24. The end portion 12 is then lowered into position with the posts 24A, 24B resting in the recesses 20A, 20B, at which point the end portion 12 can then be rotated into its final position in which the step 24 abuts the lower surface of the corresponding recess on the table portion 10. Provided that the centre of gravity of the end portion 12 lies beyond the posts 24A, 24B, the end portion 12 will then be retained in this position by gravity, in that the weight thereof will tend to force the posts 24A, 24B more firmly into the recess 20A, 20B and (likewise) force the step 24 more firmly against the recess of the table portion 10.

Removal of the end portion 12 is equally straightforward. The tip area 14 of the end portion 12 is lifted, and this will cause the end portion 12 to rotate about the posts 24A, 24B, disengaging the step 24 from its corresponding recess. The end portion 12 can then be lifted slightly to disengage the posts 24A, 24B from their recesses 20A, 20B and the end portion withdrawn.

In this way, a mechanism is provided for easily replacing the end portion 12 with an alternative end portion of a suitable profile for the treatment to be imparted to the next patient.

FIGS. 2 and 3 show the second embodiment of the invention. In this embodiment, the projections 26A, 26B along the lateral edges of the table portion 10 have a smooth upper surface and end with a rounded tip 28A, 28B. These locate within recesses 30A, 30B to replace the engagement of pins 24A in recesses 20A in the first embodiment.

Furthermore, the step 24 of the second embodiment has a reverse taper so as to form, in effect, a half dovetail joint and provide a more positive retention underneath the recess 32 (FIG. 3) of the table portion 10.

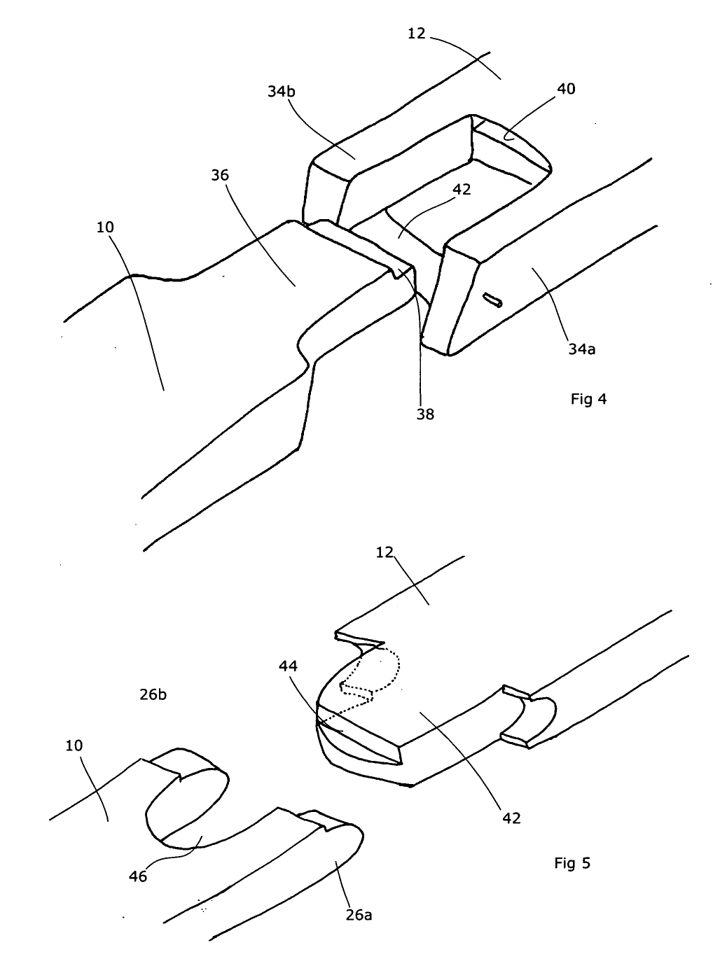

FIG. 4 shows a third embodiment of the invention. In this embodiment, the polarity of the connections is reversed such that projections 34A, 34B are extend from the lateral edges of the end portion 12 and the central projection 36 extends from the table portion 10. In this arrangement, a step 38 is formed on the projection 36 of the table portion 10 which locates under a corresponding recess 40 on the end portion 12, between the lateral extensions 34A, 34B. To provide the second engagement site in this embodiment, a ledge 42 extends between the lateral extension 34A, 34B on which the central extension 36 of the table portion 10 can rest. Thus, this embodiment again has two engagement sites, being the shoulder 38 and recess 40 and the ledge 42 and the underside of the table portion 10.

FIG. 5 shows fourth embodiment of the invention. This corresponds generally to the second embodiment shown in FIGS. 2 and 3, but the central extension 42 of the end portion 12 has a rounded tip profile 44. The recess 46 between the lateral extensions 26A, 26B has a corresponding rounded shape, although it is not essential for the two profiles to correspond precisely as gaps could be tolerated in use.

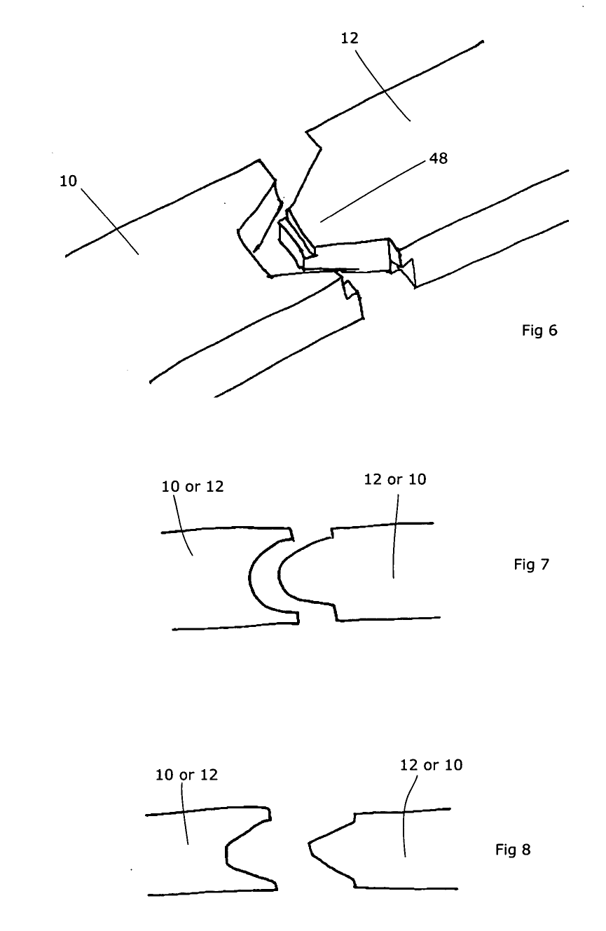

FIG. 6 shows a fifth embodiment which corresponds generally to the fourth embodiment shown in FIG. 5 except that the central extension 48 of the end portion 12 has a different profile, being angular instead of smoothly curved.

FIGS. 7 and 8 show sixth and seventh embodiments of the invention in which slightly different end profiles for the interface between the table portion 10 and the end portion 12 are shown. The precise relationship is not essential and (as noted above) the two parts need not have an identical profile.

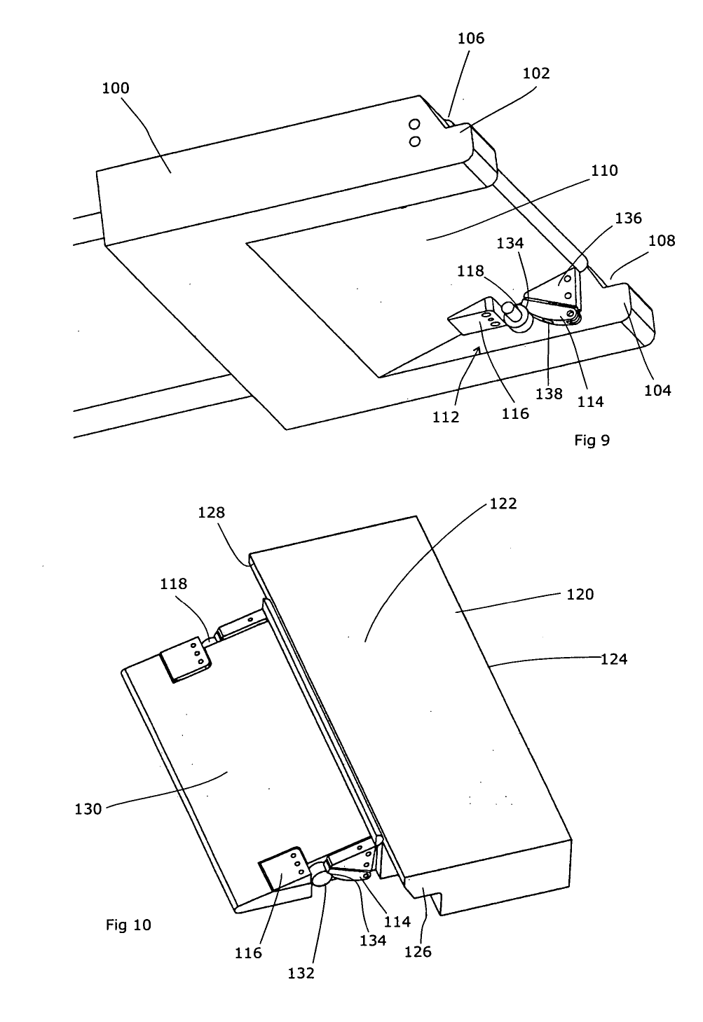

FIGS. 9, 10 and 11 show an eighth embodiment of the present invention. FIG. 9 shows the table portion 100, which has a pair of extending lip portions 102, 104 along its lateral edges. Each of these is profiled so as to include a recess 106, 108 in the area above them, so as to accept a corresponding lip on the end portion (to be described later). A recess 110 is formed between and behind the projections 102, 104, beneath which part of the end portion can locate. Within the recess 110, alongside each lateral edge and adjacent the extensions 102, 104, locating formations 112 are provided in the form of a cam surface 114. An engagement site is provided in the form of a stop 116 which protrudes into the recess 110. This stop 116 is adjustable within small tolerances via the insertion of shims as necessary.

FIG. 9 also shows a cam roller 118 for the purposes of explanation, but it should be understood that this cam roller 118 is in fact part of the end portion (not shown in FIG. 9). Thus, when the end portion is absent, the roller 118 will not be present although for the purposes of clarity it is shown in FIG. 9.

FIG. 10 shows the end portion 120 from above. This has a generally flat table part 122 on which the patient can rest, and an end profile 124. As shown in FIG. 10, the end profile 124 is rectangular but (as described above) this need not be the case and in use the end portion 120 will have a profile 124 which is adapted to its intended use. On either edge of the end portion 120, a pair of projecting lips 126, 128 are formed which correspond to the projections 102, 104 of the table portion 100. These allow the end portion 120 to rest on top of the projections 102, 104.

A central projection 130 is also provided, which fits loosely within the recess 110 of the table portion 100. This fit is not perfect, to allow for some tolerance in the fit between the two parts. As the stop 116 extends into the recess 110, the upper face of the projection 130 will abut against the stop. This and the respective lips of the two parts provide the two points of engagement of this embodiment.

On either edge of the projection 130 of the end portion 120, cam rollers 118, 132 are formed. These bear against the cam 114, and in use can roll therealong until they reach a détente 134. The cam 114 of the table portion 100 is mounted on to a substrate 136 and can be adjusted through suitable screws 138 so that its precise position can be tailored to provide a snug fit. In this way, the end portion 120 can be provided with an accurate longitudinal location. The interaction of the cam surfaces 114 and the cam rollers 118, 132 will also provide resistance to longitudinal removal of the end portion 120.

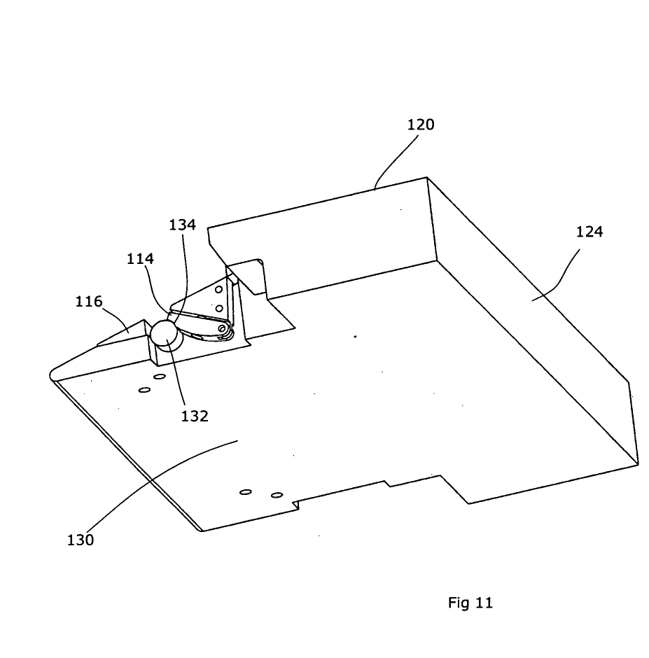

FIG. 11 shows the end portion 120 from beneath, showing more clearly the arrangement of the cam roller 132 and the cam 114, and the détente 134. It should be noted that the FIGS. 10 and 11 show the cam 114 and the end stop 116 etc although these are part of the table portion 100 not the end portion 120.

It will of course be understood that many variations may be made to the above-described embodiment without departing from the scope of the present invention.

1. A patient table comprising a main section and an end section removably attachable to the main section, each section including at least two engagement sites for mutual inter-engagement are provided on each section, with the engagement sites of each section being spaced alone the length thereof, the first engagement site closest the end of the respective section being adapted to engage on an upper surface, and the second engagement site more distant from the end being adapted to engage on a lower surface.

2. A patient table according to claim 1 in which the end section is one selected from a plurality of such sections, the plurality including sections with different shapes.

3. (canceled).

4. A patient table according to claim 3 in which the engagement sites are arranged with a central engagement site and two lateral engagement sites proximate the edges of the table.

5. A patient table according to claim 3 in which the second engagement site of each part is a ledge beneath which the first engagement site of the other parts can locate.

6. A patient table according to claim 5 in which the ledge is defined by an underlying recess.

7. A patient table according to claim 6 in which the recess is formed with a surface which angles upwardly away from the edge of the ledge.

8. A patient table according to claim 5, in which the ledge is defined by one face of a protruding pin.

9. A patient table according to claim 3 in which the first engagement sites are formed as surfaces upon which the second engagement sites can rest.

10. A patient table according to claim 9 in which the first engagement sites are provided with a profile adapted to retain engagement.

11. A patient table according to claim 10 in which the profile is a rounded recess for accepting a pin.

12. A patient table according to claim 11 in which the profile is a surface that slopes downwardly away from an edge thereof so as to be retained in a corresponding recess.
